(19) United States
(12) Patent Application Publication
(10) Pub. No.: US 2023/0338909 A1
(43) Pub. Date: Oct. 26, 2023

(54) MAGNETIC COUPLING METHOD AND MAGNETIC COUPLED STIR BAR MOTIONS AND MAGNETIC COUPLED DEVICES USING THE SAME

(71) Applicant: DUEN-GANG MOU, TAIPEI (TW)

(72) Inventor: DUEN-GANG MOU, TAIPEI (TW)

(21) Appl. No.: 18/297,618

(22) Filed: Apr. 9, 2023

(30) Foreign Application Priority Data
Apr. 21, 2022 (TW) 111115416

(51) Int. Cl. B01F 35/222; B01F 33/452; B01F 35/221

(52) U.S. Cl. CPC B01F 35/222; B01F 33/452; B01F 35/221422

(57) ABSTRACT

A dynamic magnetic coupling method employs running drive magnet(s) on a plane at in general a 90-degree angle to and below a magnetic stirring element's laying plane, and a kinetic energy transfer from the drive magnet(s) to the magnetic stirring element through a joint effect of its space velocity and the magnetic attraction force between the two, so that axle(s) to rotate the drive magnet(s) can be placed sideways in a horizontal direction. With horizontally placed axle or axles and the dynamic magnetic coupling mechanism, multiple coupling and stirring positions can be placed in parallel on a single flattened drive train and fit in hard-to-reach places. Magnetic coupling assembly of this dynamic nature allows virtual running coupling dipoles of drive magnets to be configured and reconfigured for different stir motions on the same drive train.

### CROSS-REFERENCES TO RELATED APPLICATIONS

This Application claims priority of Taiwan Patent Application No. 111115416 filed on Apr. 22, 2022, the entirety of which is incorporated by reference herein.

### BACKGROUND OF THE INVENTION

### (a) Field of the Invention

This invention relates to a magnetic coupling method and its use in magnetic coupled stir motions and devices. More particularly, the invention relates to a configurable dynamic magnetic coupling method to move or rotate one magnetic dipole or stirring element or multiple ones in a row of various motions in continuation.

### (b) Description of the Related Art

Magnetic coupling for controlled motions of an object usually involves direct coupling of a drive and a driven magnet of opposite pole types or fields of magnetism where the two are coupled in space and stay together within a finite distance of an effective magnetic force field, and the driven magnetic pole end moves with and tracks movement of the drive magnetic pole one-on-one in synchrony. When moved outside the finite distance of effective coupling, the driven magnet no longer stays together with the drive magnet and goes decoupled and wandering about and often without returning. Applications are best represented by table top magnetic stirrers used in labs to drive or rotate a magnetic dipole or stir bar by simultaneously coupling a drive magnets pair or magnetic dipole to each pole ends of the stir bar, for fluid mixing and propulsion. The axes of rotation of the drive and driven magnets are stacked in line and usually on top of an electric motor and its rotating shaft to drive the drive magnets. When multiple axes of rotation are required for parallel stirring positions, multiple motor drives or elaborate power transmission trains are required and the resulting cost, size, weight and noise may become burdensome. Electromagnets or inductive magnetic coil means of magnetic coupling may be a useful answer, but simple and efficient physical coupling for parallel stirrers/mixers in a row is still to be desired for high throughput experimentation with a device of flexibility and much reduced profile.

### BRIEF SUMMARY OF THE INVENTION

The drive or motor axis of rotation in this invention is bent 90-degree sideways and so does the drive magnets' plane of rotation. As a result, the drive and driven magnets' static coupling of the prior can no longer stay in continuation or synchrony. Instead, static coupling of the prior becomes now a timed dynamic coupling or engagement in space, i.e., the coupling of a drive magnet and a driven magnetic pole of opposite field of magnetism when the two are crossing from each other within a finite distance of an effective magnetic force field in space. Consequently, the driven magnetic dipole's spinning movement at one pole end is, on top of its own going inertia, redirected by added magnetic torque force from the drive magnet running directly under. This magnetic torque force changes with magnetic moment of the drive magnet, the running coupling distance in between, and tip speed of the running drive magnet. When in sync, dynamic coupling of the drive magnet and driven magnetic poles and subsequent redirection of the driven magnetic pole end at this one fixed point in space will take place every 360-degree turn of the drive magnet, and prompt the driven magnetic dipole into a spinning motion right above the drive magnet's plane of rotation.

Since longitudinal ends of the driven magnetic dipole or stirring element have respectively a N- and a S-magnetic-pole 180-degree apart on its spinning plane, above 360-degree coupling cycles can be refined by adding a second drive magnet of an opposite magnetic pole 180-degree apart on the first drive magnet's rotation plane. When in sync, coupling of the respective drive and driven magnetic poles and subsequent redirection of respective ends of the driven magnetic dipole will take place every 180-degree turn of the drive magnet at the one fixed dynamic coupling point in space, alternating between N-pole and S-pole ends of the stirring element, and better manage the driven magnetic dipole into a spinning motion right above the drive magnets' plane of rotation.

Still further refinement is by duplicating the above two types of one-point running coupling with a second drive or motor axis of rotation, and providing every 360- or 180-degree turn of the two drive axes a simultaneous two-point dynamic coupling of respective N-pole and S-pole ends of the stirring element: N-pole by drive magnet of S-type at one axis of rotation and S-pole by drive magnet of N-type at the other. The two axes of rotation are on a same horizontal plane and parallel to each other, and turning in opposite direction. Distance between the two simultaneous dynamic coupling points in space or of this virtual coupling dipole takes reference of end-to-end length of magnetic dipole of the stirring element, and the two dynamic coupling points are under the horizontal stirring plane and above the two vertical rotation planes of the respective drive magnets. Distance between the two vertical drive planes, as well as the distance between the two horizontal drive axes, again takes reference of end-to-end length of magnetic dipole of the stirring element.

Still further refinement is by expanding the per turn 2-time or 180-degree-apart coupling into 4-time or 90-degree-apart coupling by filling the two parallel and horizontal drive axes with two more equal drive magnetic dipoles running on the same two vertical rotation planes but each at their respective opposing drive axis and running direction. By having two of the above 2-time or 180-degree-apart running coupling configured to work in order at all 4 coupling points for a per turn 4-time or 90-degree-apart coupling, one can expect even smoother running of the stirring element with even better control. At every 90-degree turn of the two drive axes, a simultaneous dynamic coupling of respective N-pole and S-pole ends of the stirring element: N-pole by drive magnet of S-type on one axis of rotation and S-pole by drive magnet of N-type on the other in counter direction. The same repeat themselves 4 times per turn of the stirring element as well as the two drive axes with properly configured drive magnets of N-type or S-type or none under the four dynamic coupling points where vertical extensions of the drive magnets rotation planes and the two horizontal drive axes meet.

This pole-to-pole based dynamic or running coupling method allows drive magnet(s) to rotate at an angle, preferably in a plane perpendicular, to the plane the magnetic stir bar lies on; hence the use of horizontally placed drive axle or axles is now possible. A horizontal drive train not only makes flattened devices possible, but also makes it easy and flexible to scale up for multiple parallel coupling places or stir runs on a single drive train.

Dynamic, vs. static (of the prior art), magnetic coupling of this invention uses magnetic coupling fields from a set of drive magnets and their space velocity on a set of vertical rotating plane(s), hence a sequential sets of timed pull-and-push power transmissions through magnetism, which is their magnetic attraction force times velocity, when passing a preset of coupling points in space under the horizontal stirring plane, to drive and sustain a repetitive stir motion of a magnetic stirring element each time its coupled pole end(s) is or are pulled and pushed. The respective drive and driven magnetic elements or magnetic poles thus configured and coupled in space therefore do not stay together most of the time, instead they come and go with a cyclic recurrence at their respective time-lapse coupling point(s) in space and in a pre-configured manner. Furthermore, these “respective time-lapse coupling point(s) in space” can be configured and reconfigured by positioning and repositioning one or more of these drive magnets on the drive axle(s), and can create different repetitive movement of the magnetic stirring element like rotating, rocking and reciprocating motions, which will be addressed in later examples.

### BRIEF DESCRIPTION OF THE DRAWINGS

Clear understanding of this invention comes from in-depth description coupled with illustration by drawings and practical examples. Their layout and depiction are made to reveal unique features of the invention and may not limit its practice in specifics such as size, shape, dimension and their geometric ratios, and in changes made without departing from the spirit of the invention by people skilled in the art.

FIG. 1A is a three dimensional (3-D) sketch of the dynamic magnetic coupling assembly of this invention with one drive axle and one drive magnet on its circulating plane.

FIG. 1B shows side view of the magnetic coupling assembly in FIG. 1A with the drive axle and drive magnet in a virtual single pole coupling position.

FIG. 1C shows side view of the magnetic coupling assembly in FIG. 1A with the drive axle and drive magnet turned 90-degree sideways.

FIG. 1D is a 3-D sketch of the dynamic magnetic coupling assembly of this invention with a pair of drive axles and transmission spur gears and four pairs of drive magnets with the stirring element coupled to a diagonal-position virtual coupling dipole.

FIG. 1E shows a right side view of the left drive axle of the magnetic coupling assembly in FIG. 1D.

FIG. 1F shows a right side view of the right drive axle of the magnetic coupling assembly in FIG. 1D.

FIG. 2A is a top-view sketch of a t1-t2-t3-t4 time-lapsed running sequence of the dynamic magnetic coupling in FIG. 1D with a sequential 4 diagonal-position virtual coupling dipoles on an imaginary square plane to rotate a magnetic stirring element for a full turn.

FIG. 2B shows a side view of the dynamic magnetic coupling in FIG. 2A with the stirring element and a pair of the drive-magnet dipoles.

FIG. 2C shows a top plus 3-D view of a time-lapsed sketch of the dynamic magnetic coupling in FIG. 2A with a 4 points 4 diagonal-positions coupling on an imaginary square or rectangular plane, a parallel axles pair, and space orientation and pole configuration of the 4 drive-magnet dipoles, and the stirring element's turning direction.

FIG. 3A is an expanded top view of the dynamic magnetic coupling in FIG. 2A showing positions of the parallel axles pair, and space orientation and pole configuration of drive magnets at all four corners of the imaginary square plane at time t1.

FIG. 3B shows a side view of the dynamic magnetic coupling in FIG. 3A and FIG. 2A with the parallel axles pair, and space orientation and pole configuration of the 4 drive-magnet dipoles, and corresponding orientations of the magnetic stirring element at time-lapsed sequence of t1, t2, t3 and t4.

FIG. 4A shows a top view of the dynamic magnetic coupling in FIG. 3A and FIG. 2A with the parallel axles pair, and space orientation and pole configuration of the drive magnets at time t1, and the magnetic stirring element in transition from t1 to t2.

FIG. 4B shows a top view of the dynamic magnetic coupling in FIG. 2A with the parallel axles pair, and 4 diagonal-positions drive magnets' coupling sequence in transition marked t1+, t2+, t3+ and t4+ in driving a magnetic stirring element for a full turn;

FIG. 5 shows a top view presentation of axle-direction replications or scale up of the dynamic magnetic coupling in FIG. 3A and FIG. 2A to rotate a plural number of magnetic stirring elements as well as further replications of the same.

FIG. 6 shows a top plus 3-D view of a time-lapsed sketch of the dynamic magnetic coupling method of this invention in a 4 points 2 diagonal-positions coupling on an imaginary square or rectangular plane to move a magnetic stirring element for a rocking or whiplash motion with a parallel axles pair, and space orientation and pole configuration of a four drive-magnet dipoles.

FIG. 7 shows a top plus 3-D view of a time-lapsed sketch of the dynamic magnetic coupling method of this invention in a 4 points side-to-side coupling on an imaginary square or rectangular plane to move a magnetic stirring element for a reciprocating or back-and-forth rolling motion with a parallel axles pair, and space orientation and pole configuration of a four drive-magnet dipoles.

FIG. 8 shows a top plus 3-D view of a time-lapsed sketch of the dynamic magnetic coupling method of this invention in a single point coupling on a plane to rotate a magnetic stirring element with a single axle and a single drive-magnet dipole.

FIG. 9 shows a top plus 3-D view of a time-lapsed sketch of the dynamic magnetic coupling method of this invention in a single point coupling on a plane to rotate a magnetic stirring element with a single axle and a single drive magnet's monopole.

FIG. 10 shows a top plus 3-D view of a time-lapsed sketch of the dynamic magnetic coupling method of this invention in a 2-point 2 diagonal-positions coupling on an imaginary 4-side polygon plane to rotate a magnetic stirring element with a parallel axles pair, and space orientation and pole configuration of a two diagonal-positioned drive-magnet dipoles.

### DETAILED DESCRIPTION OF THE INVENTION

The following embodiments of this invention using off-the-shelf commercial magnetic stir bars and rare earth disc-shape magnets to demonstrate effective dynamic coupling of a time-lapse running nature can, like conventional fixative or static coupling, rotate magnetic stir bars for fluid mixing, propulsion and transfer, yet allow configurable designs for stir bar's captive motions and applications beyond just spinning in a flat circle. Quantitative design aided by precision magnetism, matching drive and driven torque, adjustable coupling distance and computer simulation, dedicated configuration and application of this invention are not limited to the examples revealed.

Dynamic magnetic coupling of this invention involves (1) a magnetic attraction force at a position in space between a running drive magnet and a magnetic stirring element, (2) a relative space velocity of the two at the same position, and (3) a consequent kinetic energy transmission/conversion (in the extent of the product of the magnetic attraction force and the space velocity) from the cyclically running drive magnet into a torque force to drive and sustain a repetitive motion of the magnetic stirring element. Unlike prior magnetically coupled stirrers, the drive and driven magnetic elements thus configured and coupled in space therefore do not stay together in magnetic coupling. They instead come together off and on with a cyclic recurrences at their respective time-lapse coupling point(s) in space and in a pre-configured manner. Furthermore, these “respective time-lapse coupling point(s) in space” can be configured and reconfigured by positioning and repositioning one or more of these running drive magnets on the drive axle(s), and consequently create different repetitive movement of the magnetic stirring element in continuation like rotating, rocking and reciprocating motions for fluid handling like mixing, propulsion or transfer of a multiphase nature.

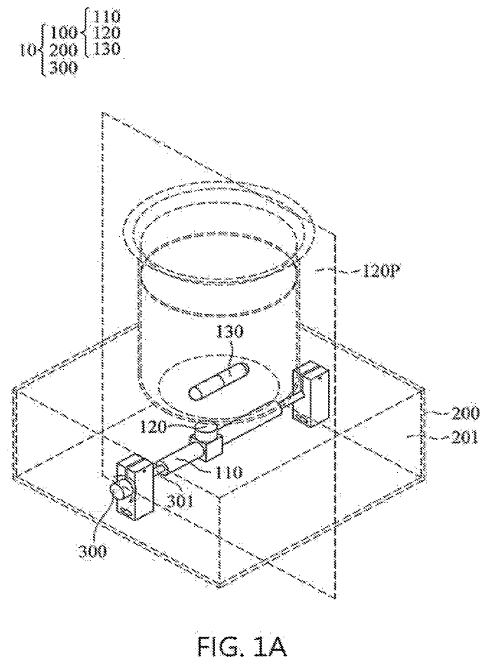

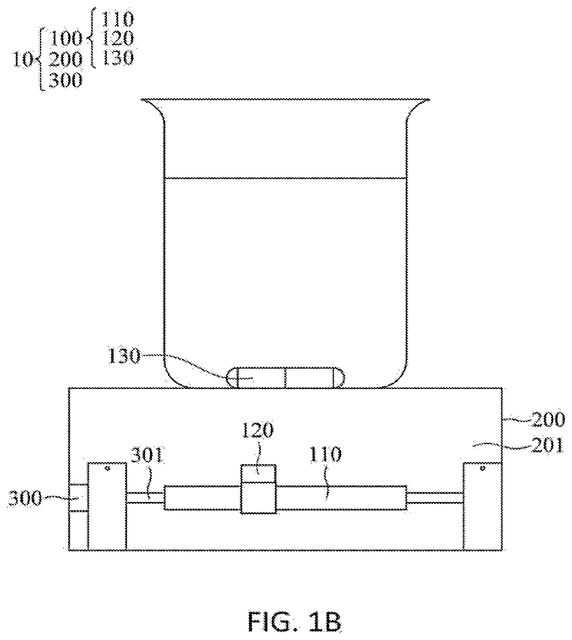

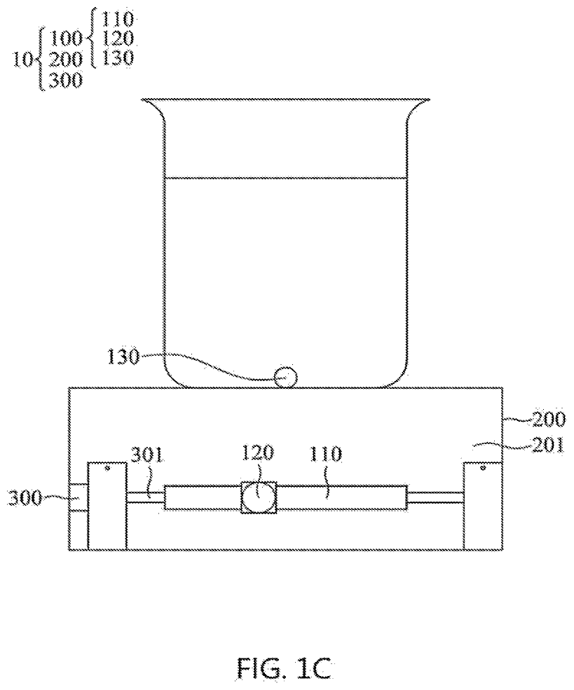

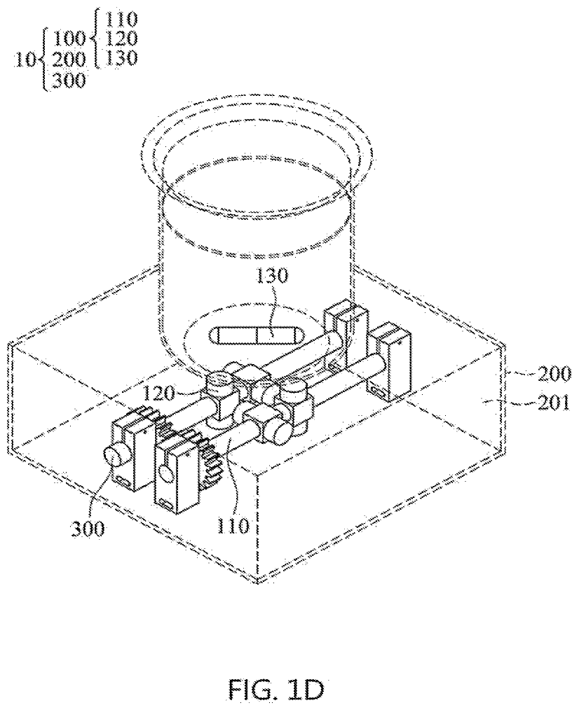

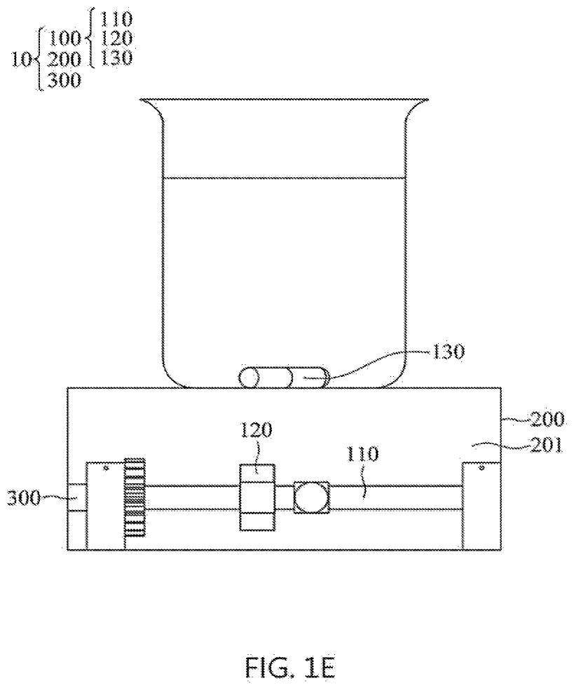

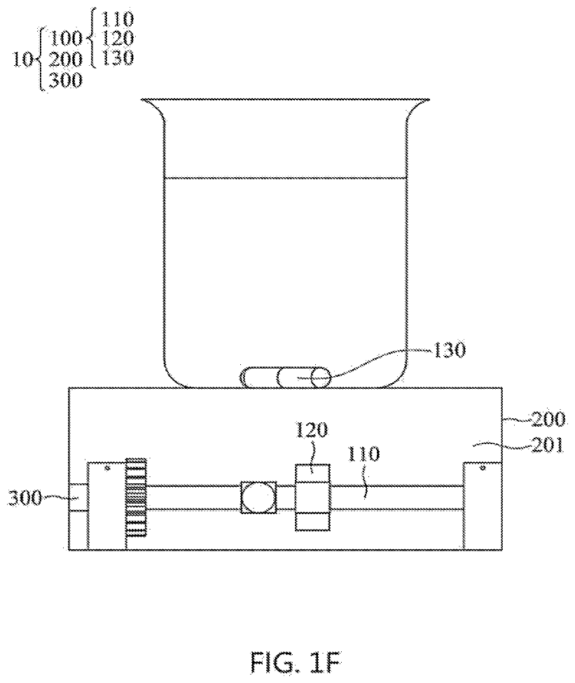

FIG. 1A shows a magnetic coupled stirring setup 10 of this invention, which has a magnetic coupled assembly 100, a chassis 200, a motor 300, and the chassis 200 has a working space 201. The motor 300 can be mounted in or out of the working space 201. The magnetic coupled assembly 100 includes a single drive axle 110, a single drive magnet 120 on the drive axle 110, and a stirring element 130. Depending on its orientation, the drive magnet 120 is either a N-type or a S-type, and has a rotation plane 120P. The drive axle 110 is powered by a drive shaft 301 of the motor 300. The horizontal placement of the drive axle 110 and the side mounting of the motor 300 are direct benefits of the dynamic coupling method of this invention. They allow easy replications of the magnetic coupled assembly 100 along the drive axle 110 for a multi-position stirring setup with minimum added cost and waste.

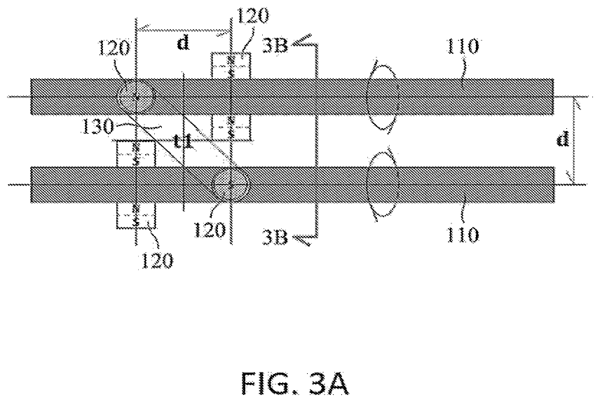

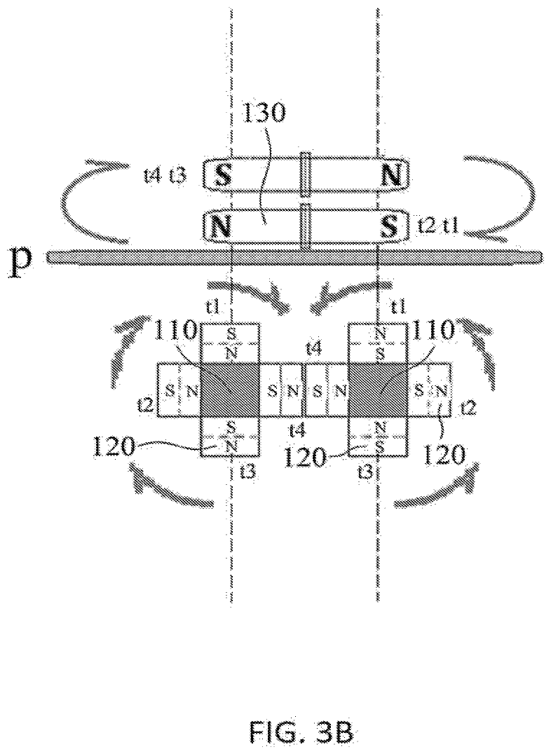

For convenience, the drive axle 110 is a material of ferromagnetic nature, such as iron or steel, and has a square cross section (as illustrated in FIG. 3B) for secure and in step anchoring of the drive magnet 120 by magnetism. The drive magnet uses types of permanent magnet like neodymium iron boron (NdFeB), samarium cobalt (SmCo), alnico, and ceramic or ferrite magnets. They can be of any shape or aggregated arrangement if of the same size and magnetism density. Commercial disc shaped magnets either in singles or in stacks can be used if they have magnetism stronger than that of the stirring element 130.

The drive magnet 120 stays under the motion plane of the stirring element 130 and within an effective magnetic coupling space away from the stirring element 130 as illustrated in FIG. 1B. The stirring element 130 in general is a magnetic stirring element. It is axially magnetized and can take a different shape with a magnetic dipole, preferably a bar, a rod or a capsule shaped one in this dynamic magnetic coupling invention for effective kinetic energy conversion from the running drive magnet(s) 120 into its motion torque and consequent movement like from FIG. 1B to FIG. 1C. High and balanced mass and magnetism at both ends of magnetic dipole of the stirring element 130 therefore enhance this energy conversion. When assisted by the motion torque of this dynamic magnetic coupling invention, one end of the stirring element 130 sitting or suspended on its motion plane is first pulled, then pushed and turned in the direction of the running drive magnet 120 and at an angle to its rotation plane. Practically a 90-degree angle between the rotation plane 120P and the stirring motion plane is used.

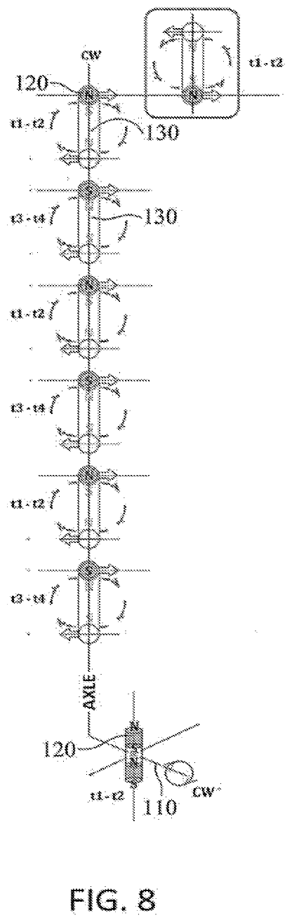

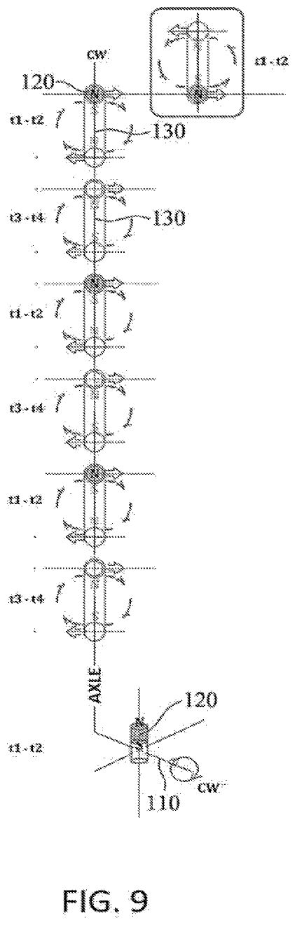

The single drive magnet 120 and single stirring pole coupling in FIG. 1A and FIG. 9 can be boosted at the same single coupling point in space, by adding a second drive magnet 120 with an opposite magnetic pole a 180-degree angle away on the drive axle 110, or in another word a drive magnetic dipole, as the arrangement in FIG. 8, on the same rotation plane 120P, for twice per turn kinetic coupling-energy conversion and boosted torque and tip or turning speed of the stirring element 130. In their first encounter, the magnetic attraction or pulling force between say the N-type drive magnet 120 and the magnetic stirring element 130's S-pole and the relative space velocity between the two produce a consequent kinetic energy conversion or a torque force transmission to drive and sustain the turning motion of the stirring element 130. Half a turn or 180-degree later, the S-type drive magnet 120 of the drive magnetic dipole comes around to meet the N-pole of the stirring element 130 at the same coupling point in space and again exerts the same magnetic pulling attraction to drive and sustain turning motion of the stirring dipole or the magnetic stirring element 130.

An expanded version of a single drive axle and single point dynamic coupling in FIG. 1A is presented in FIGS. 1D, 1E and 1F with dual drive axles 110 and up to a 4-point dynamic magnetic coupling. The drive axle 110 connected to the motor 300 turns counter synchronously with a parallel second drive axle 110 by engaging here between the two with a pair of identical spur gears, hence both drive axles will turn at the same speed but in opposite directions as shown in FIG. 1D. FIGS. 1E and 1F show respectively side views of each of the two drive axles when viewed from the right side of the drive train in FIG. 1D. Two higher levels of coupling energy transmissions from the drive magnets 120 to the magnetic stirring element 130 then become obvious and critical in this 4-point dynamic coupling configuration: one in crossing the gap between the two drive axles 110 in ways of “throw and catch” and one in gliding along the two respective drive axles 110 by a “caged trap” of magnetism, and with the former more pronounced than the latter.

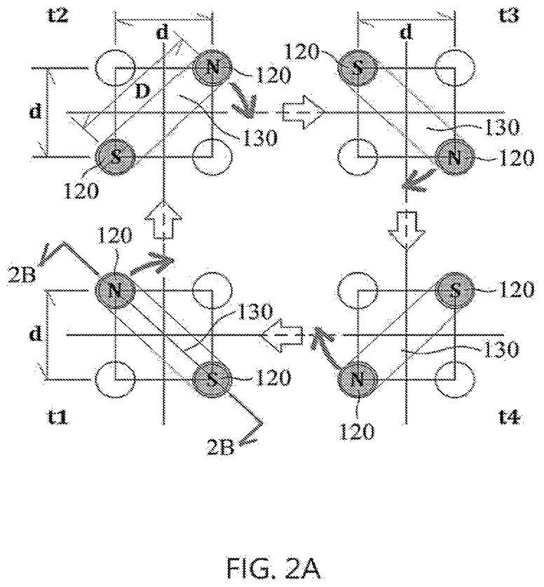

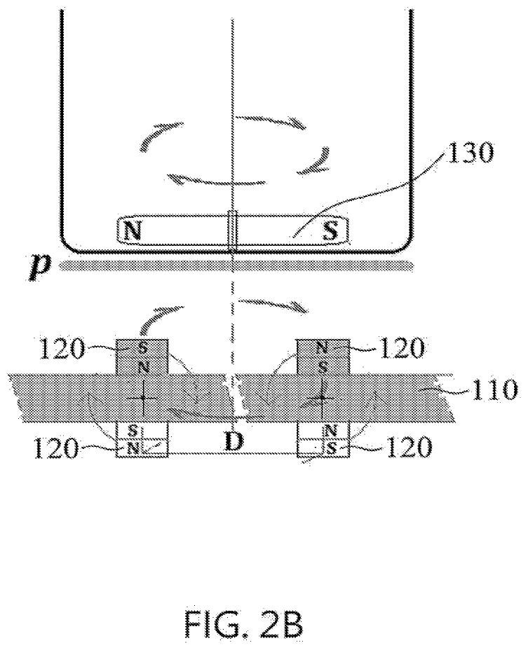

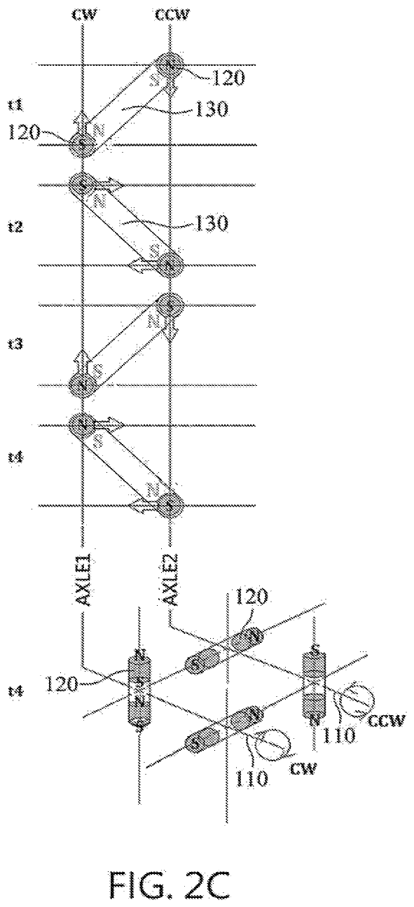

“Throw and catch” (or “pull and push” in a more literal term) originates from the two torque vectors running into or against each other when crossing between the two parallel but counter rotating drive axles 110s. This is shown in FIG. 2A with dark circles showing the drive magnets 120 and their pole types, capsule-shaped the clockwise (CW) turning, shown by four arrows, stirring element 130, and two horizontal sides of the imaginary square or rectangle the two parallel drive axles 110. The imaginary square or rectangle has sides in between the two axles of length d and diagonal D. Four time-lapse top views at t1, t2, t3 and t4 in sequence each cover one of the four ¼-turn steps of the stirring element 130. Steps t2 and t3 show respectively the beginning of the throw and end of the catch, or each of the two torque vectors first accelerates or throws and then decelerates or catches the stirring element 130 from above one drive axle to above the other drive axle. This repeats in steps t4 and t1, and again simultaneously on its two pole ends.

FIG. 2B and FIG. 2C respectively add side and 3-D views of FIG. 2A with further details of these magnetic throw and catch coupling actions. FIG. 2B is a side view of FIG. 2A at time-lapsed step t1 at a perpendicular plane of the turning stirring element 130. Stirring element 130's N-pole is right above and coupled to the turning (shown by the thin round CW turning circle) S-type drive magnet 120 on one drive axle 110 at left, and simultaneously its S-pole right above and coupled to the opposite turning (shown by the thin round counter-clockwise or CCW turning circle) N-type drive magnet 120 on the other drive axle 110 at right. Two pairs of thick turning arrows below show directions of velocity vectors of the two drive magnets on their respective left and right axles 110. These simultaneous 2-point dynamic magnetic couplings and their respective energy transmission result in the pulled-and-pushed rotation of the stirring element 130 shown by the four thick CW turning arrows above. Aided with a 3-D and top-view presentation, FIG. 2C covers full time-lapse turning cycles of all four drive magnetic dipoles 120s at t1, t2, t3 and t4 in sequence. The two opposite turning horizontal axles 110 in parallel are marked CW and CCW. Moving directions of the stirring element 130 at four sides of the dynamic coupling points are marked by short open arrows, and its magnetic dipoles marked with shaded bold capitals N and S. Drive magnets 120s at four corners of the imaginary square or rectangle are marked dark bold N and S. FIG. 2C presents the two higher levels of coupling energy transmissions from the drive magnets 120 to the magnetic stirring element 130 mentioned earlier: t2 and t4 in crossing the gap between the two drive axles 110 in ways of “throw and catch”, and t1 and t3 in gliding along the two respective drive axles 110 by a “caged trap” of magnetism. This caged-trap effect on the magnetic stirring element is created by simultaneous two dual S-type drive magnets' attraction on stirring element's N-pole side and two dual N-type drive magnets on its S-pole side in transition from t1 to t2, and the opposite takes place from t3 to t4. In principle the dynamic coupling energy transmission is more pronounced in ways of “throw and catch” in respective t2 to t3 and t4 to t1 steps than in the “caged trap” in t1 to t2 and t3 to t4.

Further detail on placement or configuration of the drive magnets 120 on the two drive axles are shown in FIG. 3A and FIG. 3B: FIG. 3A for a top view of the coupling step t1, and FIG. 3B a composite side view of all four t1, t2, t3, t4 steps in direction marked in FIG. 3A. FIG. 3A shows one embodiment of this invention where the 4-point coupling is an imaginary square with respective gap between the two parallel axles 110 and the two vertical rotation planes 120P all equal a distance d as marked. At four corners of the imaginary square and in a clockwise direction the drive magnet 120 dipoles' orientations have a 90-degree phase shift at each turn of the corner in order to spin the stirring element 130 for a full turn. FIG. 3B is a marked side view of FIG. 3A with all drive magnets 120s superimposed around the two counter rotating drive axles 110 in directions of respective thick arrows marked at left and right below. t1, t2, t3 and t4 mark respectively lapsed time locations of the responsible drive magnets 120 and corresponding stirring element 130 when engaging in order the 4-point dynamic magnetic coupling of this invention at four corners of the imaginary square right below the stirring element's laying plane p. The two drive axles 110 with their mounted drive magnets 120 below plane p may appear jammed on the graph, they can still turn all right because of the offsets and phase shifts between respectively the two vertical rotation planes and two drive axles.

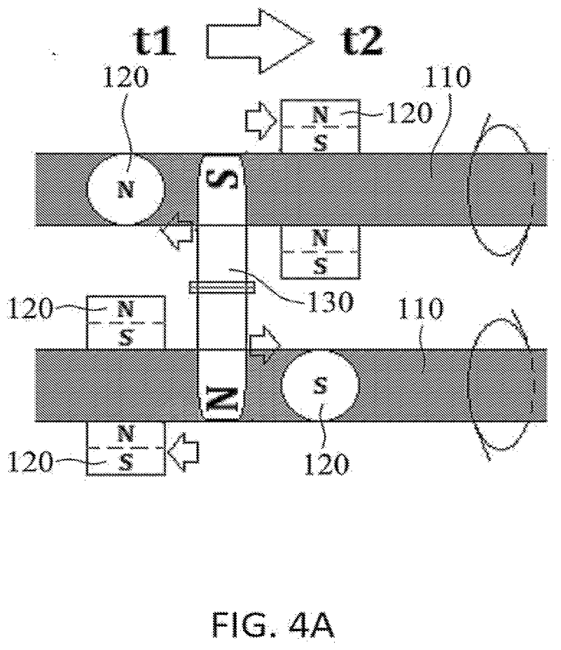

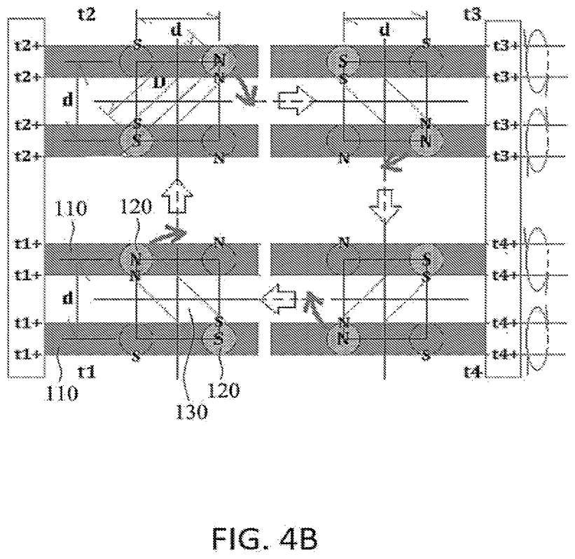

The “caged trap” effect of magnetism which comes into play in steps t1 to t2 and steps t3 to t4 when each of the two poles of the stirring element 130 glide along and above their respective drive magnets pair on each of the two axles 110 is graphically described in FIGS. 4A and 4B. During these two time-lapse transition steps, stirring element 130's S-pole moves away from the attraction pull of one drive magnet 120 N-pole to that of the neighboring drive magnet 120 N-pole coming up from below the square coupling plane, and the same with its N-pole on the other side between a pair of down and up running drive magnets 120s' S-poles below. Graphically, stirring element 130's position in between step t1 and t2 is shown in FIG. 4A while all drive magnets 120 are left at the moment of step t1 for easier reading. Caged magnetic attraction effects on stirring element 130 are labeled with four small open arrows near the respective four responsible drive magnets 120, and are critical in holding the stirring element 130 and ready it in step t2 for next round of throw and catch coupling energy transmission. The caged magnetic attraction effects at each of the four time lapse steps to make one full turn of the stirring element 130 on the square coupling plane are summarized in FIG. 4B with responsible drive magnets' positions in transition below marked Ns and Ss along the two parallel axles 110 at lapse time marked t1+s, t2+s, t3+s and t4+s for the two neighboring but 90-degree off drive magnetic dipoles 120 on respective counter turning drive axles 110, and without any pole marking on the stirring element 130.

When the drive axle's rotation goes into reverse, i.e., the two axles 110 synchronized turns change from heading into to backing away from each other, when viewed from above. Above two higher level modes of energy transmission will still be there albeit with a 90-degree shift on their time-lapse turning steps, and the stirring element 130 also reverses its turning direction to counter-clockwise. Throw and catch mode will now be carried out by drive magnets 120 pairs working in tandem on each of the two axles 110 instead of crossing between the two before. Reversible movement or turning direction of the stirring element 130 hence is also possible by reversing the drive motor rotation as in static magnetic coupling of prior art. The same is not true when running the above described dynamic magnetic coupling platform downside up by flipping the two parallel drive axles platform bottom up—now the heading into each other counter turning becomes backing away when viewed from above, hence reversed turning direction of the stirring element with the same motor drive rotation—an unique feature of the in order 4-point dynamic coupling method of this invention, such as a CW stirring on top side of the chassis 200 in FIG. 1D, and flipping the chassis over a CCW stirring with the same vessel and stir bar setup now sitting on the underside of the chassis 200.

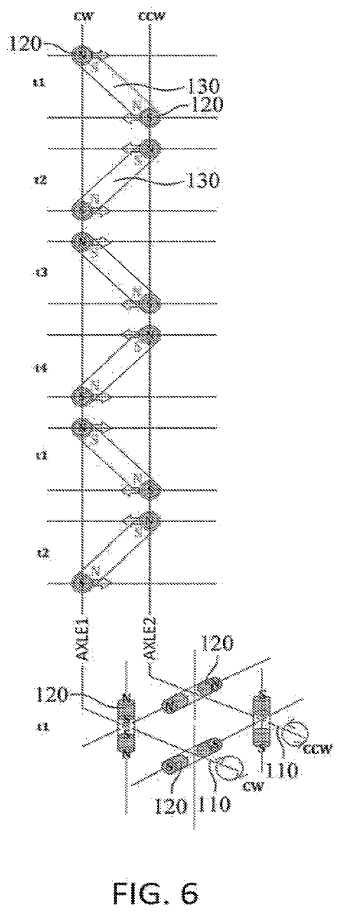

Still further embodiments by configuring and reconfiguring the four drive magnetic dipoles 120 at four corners or diagonal points of the imaginary square or rectangle for dynamic magnetic coupling can create additional turning motions among other rhythmic and repetitive motions of the stirring element 130. They are exemplified in FIGS. 6 thru 10 with accompanied validation trials in Examples 1 thru 5.

These configuration and reconfiguration of drive magnets 120 on axles 110 below each and every coupling point involve four 90-degree divisions of the 360-degree axle turn under each coupling point and up to a total of four coupling points, or a total of 16 possible proper placements or pole-selections of required drive magnets 120. In this arrangement every ¼ or 90-degree turn of the axle there are options below each coupling point to place a drive magnetic pole or not for desired coupling energy transmission or coupling motion. In embodiment examples below 1 or 2, 2 or 4, or 8 drive magnetic poles are placed respectively below 1, 2 or 4 coupling points of an imaginary square or rectangle's four corners. A single drive magnet under the coupling point will have only one coupling encounter per turn, and two drive magnets 180-degree apart under will have two coupling encounters per turn. Two drive magnets of opposite pole types under one pair of diagonal or neighboring coupling points will have also one simultaneous coupling encounter per turn, while two drive magnetic dipoles of opposite orientation under the same pair of coupling points will have two simultaneous coupling encounters with the stirring element per turn. If a drive magnetic dipole under all four coupling points, then the virtual running coupling dipole will have four simultaneous coupling encounters with the stirring element per turn. Consequently, one can create, by configuring and orchestrating these different magnetic coupling encounters, different repetitive movements of the magnetic stirring element in continuation like rotating, rocking and reciprocating motions for fluid mixing, propulsion or transfer of a multiphase nature, through the dynamic magnetic coupling method of this invention.

Successful coupling and energy transmission in the dynamic magnetic coupling method of this invention require recurring encounters of the rotating drive magnet 120 and the driven stirring element 130 at the coupling point in matching speed and frequency. Hence, relative ratio of height of drive magnet 120 above the rotating axis of axle 110 to length of stirring element 130's magnetic dipole, their coupling distance(s) or gap(s) in space, and their relative space velocity or momentum vectors in directions of their respective motion will determine how much a running speed range each of the following embodiments of this invention can deliver. Among them the imaginary square's side d and diagonal D in FIG. 2A are the primary dimensions for stirring elements size matching. In principle, d is the minimum gap width to allow counter rotating drive magnets 120 to clear one another when passing, and D is to equal dipole length of the stirring element 130 give or take one face diameter of the drive magnet 120. Actual lab stir bars may appear longer and larger because of additional inert material used in embedding the magnetic dipole. For this reason a range of sizes and shapes of commercial stir bars were tested in following embodiments for practicality of this invention. Face diameter of drive magnet 120 in general is no smaller than width of stirring element 130 and not larger than width of axle 110. Embodiments of a single diagonal or a same axle two-point tandem coupling to stirring element dipole prefer an imaginary rectangle, instead of a square, placements of the drive magnets under the stir motion plane. This suits longer and larger stirring elements in practice.

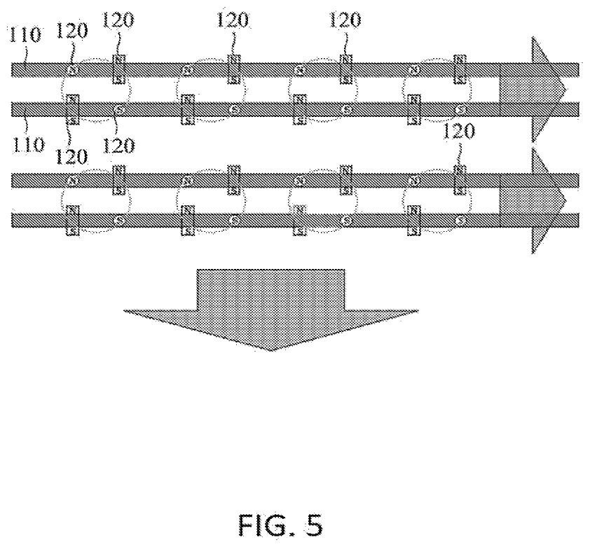

Another unique but practically main feature of this dynamic magnetic coupling invention is its scale up in term of coupling and driving a number of stir bars or stir positions in parallel can conveniently be made by repeating the unit arrangement as shown in FIGS. 1A thru 1F on the same axle or axles pair without changing the power or drive train. FIG. 5 shows from left to right four parallel stirring positions on the top axle pair, and a repeat on the second pair below. Additional axle or pair of axles can further multiply the stir positions if needed. They can all be minimally achieved with a single motor and sets of bearings and gears for motion transmission. With varied gear ratios the rotation speed can also be varied from one axle-pair to the next. They can certainly use separate drive trains and motors if so desired. More uniquely each and every stir position can be separately configured and reconfigured as needed.

Because of the two higher level modes of coupling energy transmission are in alternate play, visuals of this time-lapse coupling at low rpm showed somewhat lapsed stir bar movement when turning. This disappeared as speed increased. However, when functional coupling conditions do not exist, this lapsed movement causes stir bar at low rpm to decouple for not getting sufficient “throwing” torque, and at high rpm for too much at coupling end(s) of the stir bar. In the former the stir bar may wonder and move at random, and the latter popping, jumping and then stray and stay out. Using FIG. 2A as an example, virtual running coupling dipoles change four times per clockwise turn of the stir bar: [N-X-S-X]-[X-N-X-S]-[S-X-N-X]-[X-S-X-N] and X stands for blank positions here. Also noted are changing magnetic fields on each of the four sides of the imaginary square plane, such as [N-X]-[X-N]-[S-X]-[X-S] at the top side, and each of the four sides are capable of this auxiliary dynamic coupling of their own on the run away stir bar, i.e., first t1 and t2 pulled-and-pushed at S-pole end, and then t3 and t4 the N-pole end to make one turn. This is still another unique feature of the dynamic coupling method of this invention not existing in stir bar's static magnetic coupling of prior art. If planned functional coupling conditions do exist, this auxiliary dynamic coupling sequence may train and spin the “uncoupled” stir bar off-and-on and, in marginally uncoupled cases, pull it back into its planned coupling motion. This is due to the gentle and forgiven feature of the dynamic coupling method of this invention when the stirring element is stationary or stray out of the imaginary square or rectangle coupling plane. This also shows in its easier retrieval when replacing stir bar in vessel.

Five example embodiments below deploy various configurations of the magnetic coupling assembly to show the use and versatility of the dynamic magnetic coupling method of this invention in creating various stirring motions of a magnetic stirring element:

| | Coupling Points, Stepping Angle, Repetitive Motion | |
|---|---|---|
| | Types | FIGS. |
| 1 | Dual axles 4-point dipoles, every ¼ turn, turning | 2A thru 4B |
| 2 | Dual axles 4-point dipoles, every ¼ turn, non-turning | 6 & 7 |
| | rocking & reciprocating | |
| 3 | Single axle 1-point dipole, every ½ turn, turning | 8 |
| 4 | Single axle 1-point monopole, every turn, turning | 9 |
| 5 | Dual axles 2-point dipoles, every ½ turn, turning | 10 |

Example 1: Four driving dipoles on dual axles to run stir bar every ¼-turn for repetitive turning motion (FIGS. 1D through 4B) As shown in FIG. 1D two 6 mm stainless steel round shaft were each clamped down in parallel with self-lubricating bearing pair on a flat surface, and then fitted each with two hollowed out 8 mm cubes of carbon steel blocks to sit the drive magnets or magnetic poles by magnetism, and the distance between them and their angular alignments on the two 6 mm round shafts can be adjusted with set screws on each block. This makes a pair of parallel axles and on them face-to-face two pairs of steel blocks, and in between a center-to-center distance d of 20 mm to mount and configure the drive magnets. Two sizes of rare earth disc magnets 5 mm in height (H) were used: one 5 mm in diameter (Di) for less magnetic moment and one 8 mm in diameter for higher magnetic moment as drive magnets. Hence, in this embodiment, the running dipoles on each of the four rotating steel cubes had an end-to-end length of 18 mm, i.e., two magnets of 5 mmH each plus the steel block of 8 mmH. Three ranges of drive axle speed of 35-165, 130-440 and 210-1080 rpm were provided by respectively one 7 W and two 13 W 12V DC geared motors, and within each range 6-speed selections by varying the DC-volt outputs. Opposing but synchronous rotation on the other axle was carried out by two identical spur gears of proper size mounted and engaged on and between the two turning shafts 20 mm apart.

Practical running variables include size and type of stir bars, mixing vessels, motor or stirrer rpm, and vertical distance of the coupling space between drive magnets and magnetic stir bar, and were tried as the following:
Types of stir bar—rod shaped stir bars of triangular, cylindrical, octagonal and square cross sections with or without a center pivot ring, and long oval shaped ones;
Sizes of stir bar—15 to 60 mm in length and 7 to 14 mm in diameter or height;
Vessel types—matching 50 to 600 mL glass beakers and a 2000 mL plastic beaker with tap water at room temperature about 20° C.;
Stirrer rpm—scores of functional (Yes), partial functional for no less than 3-turn on one location (Yes/No) and erratic (No) coupling were recorded at three speed ranges of the three 6-speed DC motors tested—respectively 35/60, 80/105, 125/165 rpm for the 7 W low speed motor, 132/186, 225/273, 324/440 rpm the 13 W mid speed motor, and 210/370, 530/680, 820/1080 rpm 13 W high speed motor, all motor speed are approximate value and allow ±10% error;
Coupling distance—on top of a base gap of 5 mm (space below plane p) three sheets of Plexiglas of 4 mm thick each were used as spacer for the test, hence, at about 9, 13 and 17 mm apart in addition to vessel wall thickness at bottom. At a 28 mm D or a d of 20 mm and the various motor speeds tested, functional magnetic coupled stirring were observed with 15-40 mm stir bar length (L). Eight millimeters diameter disc magnets and longer coupling distance performed significantly better than the 5 mm ones at shorter coupling distance. Shorter stir bars coupled better at the low 35-165 and longer stir bars mid 130-440 rpm range. However, when switched to the top speed motor, all 15-40 mmL round rod shape stir bars with or without center pivot ring had functional stir in its entire 350-1080 rpm speed range. Longer coupling distance performed better at low rpm for its reduced “kicking” torque, but shorter coupling distance to gain higher “kicking” torque was essential at high end of stirrer speed.

Functional dynamic coupling depends on coordination of pull and push attraction force between stir bar and drive magnets, or proper overlap of their respective motion inertia and drive torque. Critical parameters may include their respective tip speeds, dipole length, number of coupling points and pole-to-pole coupling distance. Mathematical modeling of these parameters for improved coordination and overlap of their respective motion inertia and drive torque may further enhance performance and application of the dynamic magnetic coupling method of this invention. One obvious condition may involve matching tip speed of stir bar and that of the driving magnet give and take the amount of power dissipation in mixing so that timing of coupling would be always in sync. Stir bar rotation in this embodiment could be reversed when DC motor and the shaft-pair were made to turn in the other direction.

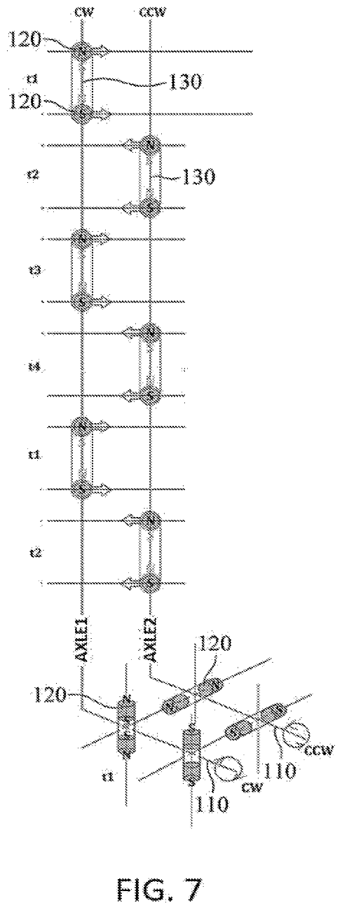

Example 2: Four driving dipoles on dual axles to run stir bar every ¼-turn for repetitive non-turning rocking and reciprocating motions (FIGS. 6 and 7) Four magnetic drive dipoles of Example 1 were reconfigured as in FIGS. 6 and 7 and tested with a 13 W 60-220 rpm low speed motor to create instead of spinning new repetitive stir bar movements of, respectively, rocking and reciprocating motions. The former were run using a 38 mm-long (L) and 8 mm-wide (W) octagonal shaped stir bar with center pivot ring and the latter smooth cylindrical shaped stir bar of a comparable size. Both worked out as expected. The reciprocating motion coupling also allowed, before pulling back, stir bar's linear traveling beyond boundary of the imaginary square or gap d between the shaft-pair with adjustment on the coupling distance or drive magnets' strength.

Hence, in addition to clockwise and counter clockwise rotation, new low-shear stir motion repertoire is now possible with magnetic stir bars of various sizes and shapes and the configurable construct of this invention. Distance between two dipoles on same drive shaft can vary to match stir bar's dipole length. The imaginary square for stir bar coupling in Example 1 is now an imaginary rectangle. Amplitude or linear travel of stir bar motion was not necessarily bound by distance between the parallel shafts pair either. If functional coupling condition exists, suspended stir bar may be coupled and manipulated the same way inside a mixing vessel. Therefore, magnetic coupled low-shear motions like a repetitive rocking whiplash and a repetitive reciprocating rolling of this invention may further expand magnetic stirrer and stir bar's application.

Still embodiments of this invention show further simplified construct using one single axle to rotate a single drive dipole to spin a magnetic stir bar at a 90-degree angle. FIG. 8 shows time-lapse positions of one drive dipole's N and S poles and one coupled stir bar dipole at a single coupling point. This is different from the 2-point coupling drives at both ends of stir bar in Example 1 and Example 2. Consequently, stir bar alignment in respect to the vertical drive dipole prior to coupling may have two degrees of freedom, i.e., at either side of the drive dipole. The time-lapse top views in FIG. 8 show that on one side of the drive plane one has a CCW-spin of stir bar as shown in the insert box, and the opposite side a CW-spin. Either opportunistic coupling engagement may just be a “training” encounter before the eventual locking-on choice, which depends on vessel geometry and fluid flow. These are the trials in Example 3.

Example 3: Single driving dipole on single axle to run stir bar every ½-turn for repetitive turning motion (FIG. 8)

Trials were carried out as the following
Types of stir bar—rods of cylindrical, octagonal and oval shape with or without a center pivot ring;
Sizes of stir bar—15 to 40 mmL and 7 to 9 mmDi or height (H), in particular a 27 mmL and a 40 mmL smooth cylindrical rod of respectively 8.5 and 9.0 mmDi;
Vessel types—to avoid stir bar bumping onto sidewall, matching 100, 400 (Tall Form) and 600 mL glass beakers with inside diameter no less than twice the length of stir bar were tried and tested;
Drive magnets—larger rare earth disc magnets of 8 mmDi/10 mmH and 12 mmDi/5 mmH were tried in addition to the two sizes used in Example 1 and Example 2;
Stirrer rpm—scores of functional (Yes), partial functional (Yes/No) and erratic (No) coupling were recorded at three speed ranges of the three 13 W 6-speed DC motors tested—respectively 60/90, 110/135, 165/220 rpm for the low range, 132/186, 225/273, 324/440 rpm for the mid range, and 300/450, 540/675, 810/1100 for the high range;
Coupling distance—at a base gap of 5 mm (7 mm for larger 12 mmD/5 mmH and taller 8 mmD/10 mmH drive magnets) between vessel bottom and tip of a vertical drive dipole, added coupling distances tested with 1, 2 or 3 sheets of Plexiglas of 4 mm thick each were respectively 9/13/17 mm for the smaller drive magnets and 11/15/19 mm for the larger ones.

Of the various motor speeds tested, functional coupling to mid size 8 mmDi/5 mmH drive magnets were observed for stir bar 15-30 mmL at 130 to 800 rpm or higher. This is particularly true for smaller stir bar and stir bar with center pivot ring. Longer smooth cylindrical stir bar of 9.0 mmDi/40 mmL also worked at 130-450 rpm. Larger and heavier or smaller and lighter disc magnets also worked but their top stirring speed were not as high. This included the 12 mmDi/5 mmH bigger face magnets, but top speed difference between 8.5 mmDi/27 mmL and 9.0 mmDi/40 mmL stir bars was less obvious here.

The opportunistic coupling engagement to change stir bar's spinning direction and the “training” of a runaway stir bar were frequently observed in trial runs above. Axis of rotation of coupled stir bar also changed its location from behind the rotating axle to its front with increasing rpm within the functional dynamic coupling range of this embodiment. This reflects again the kinetic energy transmission of this dynamic magnetic coupling invention: low rpm coupling at low linear velocity side of the rotating running magnet and high rpm the opposite, and with equilibrium in the middle, i.e., right on top of the rotating axle. With a fixed driving dipole length, longer stirring elements are handicapped above because of their need of higher tip speed or motion inertia. Stable high speed tumbling of short stir bars, like 8 mmDi/15 mmL octagonal shape with center pivot ring and 7 mm wide (W)/19 mmL oval shape, at more than 1,000 rpm without a “jumping flea” kind of decoupling of prior art's static magnetic coupling was also unique with this embodiment of single point dynamic running coupling. It shows that with single point coupling the coupling angle is not limited to 90-degree—with short free stir bar or mounted stir bar it can go as much as 180-degree, or spinning the stir bar standing on its pole ends in running direction of the drive magnets.

Instead of two “kicks” per turn at one pole-end after the other, magnetic stir bar in this next embodiment example gets only one “kick” per turn at just one-pole end at a single coupling point on the imaginary plane for pairing and spinning as shown in FIG. 9. One would expect, when compared to Example 3, a larger magnet or more magnetic pull-and-push force may be needed for a higher “kicking” torque on one side of stir bar to make the full turn. The same two-degree of freedom opportunistic coupling engagement and “training” encounters as Example 3 may still occur. Both embodiments offer further simplification for scale up to a novel multi-position magnetic stirring.

Example 4: Single driving monopole on single axle to pull-and-push stir bar once per turn for repetitive turning motion (FIG. 9)

Experimental trials were carried out the same way as in Example 3 except the vertical rotating dipole is now a rotating mono-N-pole. A residual S-pole magnetic field still existed from this drive magnet and is neglected here for its relative distance and dispersion on the rotating steel shaft.
Types of stir bar—rods of cylindrical and octagonal shape, the former are smooth without a center pivot ring, and the latter with center pivot ring;
Sizes of stir bar—a 27 mmL and a 40 mmL cylindrical rods of respectively 8.5 and 9.0 mmDi, plus a 28 mmL and a 41 mmL octagonal rods of 8 mm Di;
Vessel type—600 mL glass beakers with 450 mL tap water at 20° C. room temperature;
Drive magnets—disc magnets of 12 mmDi/5 mmH, 8 mmDi/5 mmH and 8 mm Di/10 mm H;
Stirrer rpm—as before scores of functional (Yes), partial functional (Yes/No) and erratic (No) coupling were recorded at three speed ranges of the three 13 W 6-speed DC motors tested—respectively 60/90, 110/135, 165/220 rpm for the low speed motor, 132/186, 225/273, 324/440 rpm for the mid speed motor, and 300/450, 540/675, 810/1100 for the high speed motor;
Coupling distance—at a base gap of 7 mm between vessel bottom and tip of a vertical drive dipole, coupling distance were added and tested with 1, 2 or 3 sheets of Plexiglas of 4 mm thick each, hence respectively 11/15/19 mm.

With the 12 mmDi drive magnet functional coupling to smooth cylindrical stir bar of 9.0 mmDi/40 mmL only worked in a limited speed range of 100-250 rpm, whereas the 8.5 mmDi/27 mmL one slightly higher to 300 rpm. Effective coupling distance was shorter for the shorter stir bar in order to have better tip-to-tip or pole-to-pole cycling timing, hence sufficient torque to make a faster full turn. Same short distance on the other hand was detrimental for longer stir bar, hence lower rpm or more distance for its functional coupling.

Although they are supposed to spin easier and free, comparable size stir bars with center pivot ring in the same test came out with mixed results on their functional stir speed range. The 28 mmL octagonal rod worked out a better functional stir range of 60-450 rpm, whereas the 41 mmL one down shifted to 60-190 rpm. Unlike their smooth counterpart above without the center pivot ring, both came out better at high end of their effective coupling distance as their easier spin with center pivot ring require less spinning torque.

Smaller face disc magnets of 8 mmDi/5 mmH and 8 mmDi/10 mmH were thought to give respectively more precise or powerful pull and push on the magnetic stir bar, but were of no avail.

Above example suggested that both stir bars with and without center pivot ring showed the disadvantage of one kick instead of two (as Example 3) in this running coupling by a single drive magnet, but functional fluid mixing still at a relatively low rpm range. Both Example 3 and Example 4 can use additional drive dipole(s), sit in tandem and configured accordingly, to aid their kicking torque on the stir bar large or small. They also show that at a single point coupling the coupling angle is not limited to 90-degree as described earlier—with either short free stir bar or mounted stir bar it can go as much as 180-degree, or spinning on stir bar's ends. Hence, functional dynamic couplings of this invention are not limited to just a 90-degree intersection of the drive and the driven planes. Additional applications may consider other angle of intersection for novel or improved performance of magnetic coupled stirring in different planes inside a mixing vessel.

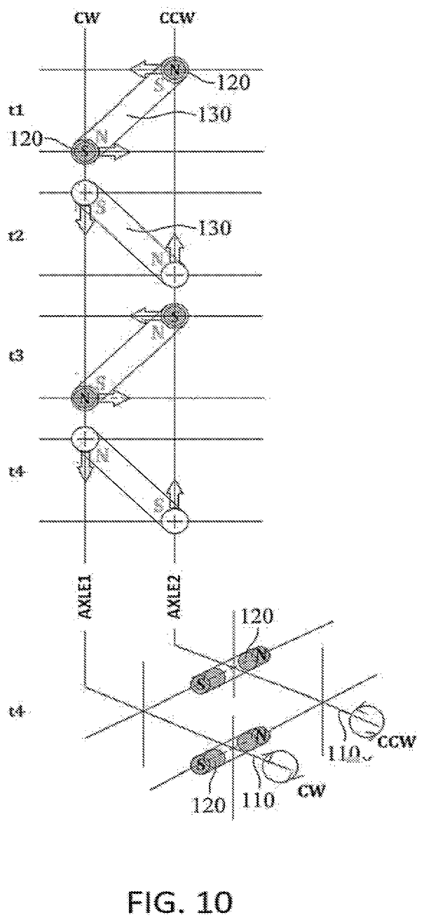

Obviously there are still configurations in between the 4-point coupling of Example 1 and single point coupling of Examples 3 and 4. One example is a one diagonal 2-point coupling which is half of the 4-point coupling action in Example 1 and doubles of the single point coupling in Examples 3 and 4. FIG. 10 is a double version of Example 3 and its testing result is described in example below. Depending on which diagonal coupling one picks, magnetic stir bar will have a different spinning direction with same set rotation of the drive axle pair.

Example 5: Two driving dipoles on dual axles to run stir bar every ½-turn for repetitive turning motion (FIG. 10)

This dual points coupling is a double of single point coupling of Example 3 which therefore serves as reference for comparison. Trials were carried out as the following.
Types of stir bar—rods of smooth cylindrical shape and octagonal with a center pivot ring;
Sizes of stir bar—25 to 50 mm in length and 8 to 10 mm in diameter or height stir bars were tested, including a 27 mmL and a 40 mmL smooth cylindrical rod of respectively 8.5 and 9.0 mmDi and comparable size 25 mmL and 38 mmL octagonal ones with center pivot ring and 8 mmDi.
Vessel type—600 mL glass beakers with tap water at 20° C. room temperature;
Drive magnets—disc magnets of 8 mmDi/5 mmH in Examples 1 thru 3 were used;
Stirrer rpm—scores of functional (Yes), partial functional (Yes/No) and erratic (No) coupling were recorded using only the high speed 13 W 6-speed DC motor at 300/450, 540/675, 810/1100 rpm;
Coupling distance—at a base gap of 5 mm between vessel bottom and tips of two vertical drive dipoles, added coupling distances tested were respectively 9/13/17 mm using 1, 2 or 3 sheets of Plexiglas of 4 mm thick each. In addition to the imaginary square plane arrangement of sides d of 20 mm for the diagonal coupling to a pair of drive magnets, a rectangular one of 40 mm long (on each of the two shafts) and 20 mm across was also used to drive the longer stir bars. Running coupling at two diagonal points on the imaginary square plane every ½-turn worked well over the entire rpm range (300-1100 rpm) in driving the four rod-shape stir bars 25-40 mm in length, a big improvement not only over the single point coupling of Example 3, but also in par with the more elaborated four-point and 4-step coupling of Example 1. Using the 40 mm×20 mm imaginary rectangular coupling plane and two drive magnetic dipoles at diagonal corners gave a 50 mmL/10 mmDi octagonal stir bar with center pivot ring an effective stirring speed up to 675 rpm, a significant improvement from 440 rpm of the same stir bar in Example 1. The 25 and 38 mm octagonal stir bars with center pivot ring on the contrary saw their effective stirring speed down to 675 rpm or lower here because the extended coupling distance is beyond their reach.

Stir bar rotation in this embodiment also could be reversed when DC motor and the axle-pair were to turn in the other direction.

Other than simplification, two-point coupling of this invention also allow easy reconfiguration of coupling torque arm length to fit larger and longer stir bars. Dynamic magnetic coupling method and assembly of this invention again demonstrate their configurable and reconfigurable utility according to stir motion needs, such as motion types, direction of rotation and size/shape of magnetic stir bar, not known and available prior.

I claim:

1. A dynamic magnetic coupling method, which, at a coupling point in space, transforms the magnetic attraction force between a drive magnet and a stirring element and the accompanying kinetic momentum of the drive magnet into a motion torque and speed of the stirring element, so that said drive magnet and said stirring element produce a rhythmic and cyclic coupling encounter and corresponding stirring motion, wherein said drive magnet has a single magnetic pole to attract one end of said stirring element; said drive magnet moves in a circle on a rotation plane perpendicular to a horizontal drive axle to which said drive magnet is attached, comprising:
step 1: a horizontally placed drive axle and a drive magnet attached to said drive axle with said magnet's drive pole pointed in or facing direction perpendicular to said drive axle's turning axis,
step 2: a stirring element on its laying plane, magnetically attracted to said drive magnet under and right above said drive magnet's circular rotation plane, and two said planes intersecting at an angle,
step 3: every turn in a finite direction of said drive axle and attached drive magnet produces one said coupling encounter, at a virtual coupling point in space, right under the attracted end of said stirring element, and a said transformation of said kinetic momentum of said drive magnet into said motion torque and speed of the stirring element,
step 4: said stirring element so attracted and pulled-and-pushed in a cyclic manner by said drive magnet in turn moves in repetitive turning motions on its said laying plane in sync with motions of said drive magnet on said drive axle,
step 5: while said synchronization persists, said stirring element's turning speed can be adjusted by said drive axle's turning speed,
step 6: direction of said stirring element's turning motion may change according to which end of said stirring element's two ends is coupled,
step 7: condition allowing said synchronization depends on size and mass of said stirring element, size and magnetic strength and space velocity of said drive magnet, and space gap at said virtual coupling point and between said stirring element's laying plane and peak of said drive magnet's circular rotation plane, and
step 8: said space velocity of said drive magnet also a function of said drive magnet's circular rotation plane's diameter or pole height from said drive axle's turning axis.

2. The dynamic magnetic coupling method of claim 1, wherein said stirring element's laying plane intersects with said drive magnet's rotation plane at 90-degree.

3. The dynamic magnetic coupling method of claim 1, wherein said drive magnet can be an aggregate of a plural number and positioned next to one another, and line the same said rotation plane on said drive axle to affect its magnetic attraction force to said stirring element.

4. The dynamic magnetic coupling method of claim 1, wherein said drive magnet of a single pole type can be a drive magnetic dipole of one N-type and one S-type poles 180-degree apart and attached in symmetry on and perpendicular to said drive axle, when circulating said drive axle on said rotation plane, a stirring element of one N-type and one S-type magnetic pole ends are attracted and pulled-and-pushed in turn every half-a-turn of said drive axle and driven in cyclic and repetitive turning motions on its laying plane in sync with motions of said drive magnetic dipole.

5. The dynamic magnetic coupling method of claim 1, wherein said coupling point in space are two, and positioned at a diagonal of an imaginary square or rectangle under the laying plane of said stirring element, and said drive axle are two; at the diagonal are a pair of a first drive magnet and a second drive magnet of opposite pole types; the two drive axles are a parallel pair of a first drive axle and a second drive axle, and are placed under and along opposite sides of said imaginary square or rectangle, with said first drive magnet mounted on said first drive axle and said second drive magnet on said second drive axle in tandem; length of said diagonal or the virtual magnetic coupling dipole or distance between said two drive magnets in tandem is adjustable and to match dipole distance or length of said stirring element and affect said magnetic attraction force; when said first drive magnet circulating said first drive axle in sync but in a counter direction of said second drive magnet circulating said second drive axle on respective rotation planes perpendicular to their respective drive axles, a stirring element of one N-type and one S-type pole ends, attracted and pulled-and-pushed simultaneously at said two ends by said virtual magnetic coupling dipole at said diagonal once every turn of said two drive axles, moves in repetitive rotary motion in one finite direction above said imaginary square or rectangle plane.

6. The dynamic magnetic coupling method of claim 1, wherein said coupling point in space are two, and positioned at a diagonal of an imaginary square or rectangle under the laying plane of said stirring element, and said drive axle are two; at the diagonal are a parallel pair of a first drive magnetic dipole of one N-type and one S-type poles 180-degree apart and a second drive magnetic dipole of a reversed polarity and attached in symmetry on and perpendicular to said two drive axles; wherein said two drive axles are a parallel pair of a first drive axle and a second drive axle, and are placed under and along opposite sides of said imaginary square or rectangle, with the first drive magnetic dipole attached on the first drive axle and the second drive magnetic dipole on the second drive axle parallel to said first drive magnetic dipole; length of said diagonal or the virtual magnetic coupling dipole or distance between said two drive magnetic dipoles is adjustable and to match dipole distance or length of said stirring element and affect said magnetic attraction force; when said first drive magnetic dipole circulates said first drive axle in sync but in a counter direction of said second drive magnetic dipole circulating said second drive axle on their respective rotation planes perpendicular to their respective drive axles, a stirring element of one N-type and one S-type pole ends, attracted and pulled-and-pushed simultaneously at said two pole ends by said virtual magnetic coupling dipole at said diagonal once every one-half turn of said two drive axles, moves in repetitive rotary motion in one finite direction above said imaginary square or rectangle plane.

7. The dynamic magnetic coupling method of claim 1, wherein said coupling point in space are four, and positioned at four corners of an imaginary polygon plane with four sides, wherein said polygon has two pairs of parallel sides meeting in right angles, and said drive axle are two; wherein said two drive axles are a parallel pair of a first drive axle and a second drive axle, and are placed under and along one said pair of parallel sides of said imaginary polygon; under four corners of the polygon are four pairs of said drive magnets or four magnetic dipoles of one N-type and one S-type poles 180-degree apart and each attached in symmetry on and perpendicular to said two drive axles; they are in turn a first drive magnetic dipole, a second drive magnetic dipole, a third drive magnetic dipole and a fourth drive magnetic dipole, said first and third dipoles are parallel to said imaginary polygon plane with same pole orientation at one diagonal, and said second and fourth perpendicular to said imaginary plane but with opposite pole orientation at the other diagonal as the virtual coupling dipole in transient; said first and second dipoles positioned on said first drive axle with a 90-degree offset and said third and fourth on the second drive axle also with a 90-degree offset, and said first and said third in parallel; when said first and second drive magnetic dipoles circulating said first drive axle and the third and fourth circulating said second drive axle in sync but counter direction on planes perpendicular to said two drive axles, a stirring element of one N-type and one S-type pole ends, attracted and pulled-and-pushed simultaneously at said two pole ends by said virtual coupling dipoles preconfigured in turn at each of the four diagonals once every ¼ turn of said two drive axles, moves in repetitive rotary motion in one finite direction above said imaginary polygon plane; length of said diagonals or virtual coupling dipoles is adjustable and to match dipole distance or length of the stirring element and affect said magnetic attraction force.

8. The dynamic magnetic coupling method of claim 1, wherein said coupling point in space are four, and positioned at four corners of an imaginary polygon plane with four sides, wherein said polygon has two pairs of parallel sides meeting in right angles, and said drive axle are two; wherein said two drive axles are a parallel pair of a first drive axle and a second drive axle, and are placed under and along one said pair of parallel sides of said imaginary polygon; under four corners of the polygon are four pairs of said drive magnets, each with a same pole type 180-degree apart and attached in symmetry on and perpendicular to said two drive axles; they are in turn a first drive magnets pair, a second drive magnets pair, a third drive magnets pair and a fourth drive magnets pair, said first and third drive magnets pairs of opposite pole types at one diagonal are parallel to said imaginary polygon plane, and said second and fourth also of opposite pole types perpendicular to said imaginary plane at the other diagonal as the virtual coupling dipole in transient; said first and second drive magnets pairs of opposite pole types positioned on said first drive axle with a 90-degree offset and said third and fourth also of opposite pole types on said second drive axle also with a 90-degree offset; said first and fourth drive magnets pairs are of one pole type and said second and third the opposite pole type; when said first and second drive magnets pairs circulating said first drive axle and said third and fourth circulating said second drive axle in sync but counter direction on planes perpendicular to said drive axles, a stirring element of one N-type and one S-type pole ends, attracted and pulled-and-pushed simultaneously at both ends by said virtual coupling dipoles preconfigured in turn at each of said two diagonals once every ¼ axle-turn, moves in repetitive back-and-forth rocking or whiplash motion above said imaginary polygon plane; length of said diagonals or virtual coupling dipole is adjustable and to match dipole distance or length of the stirring element and affect said magnetic attraction force.

9. The dynamic magnetic coupling method of claim 1, wherein said coupling point in space are four, and positioned at four corners of an imaginary polygon plane with four sides, wherein said polygon has two pairs of parallel sides meeting in right angles, and said drive axle are two; wherein said two drive axles are a parallel pair of a first drive axle and a second drive axle, and are placed under and along one said pair of parallel sides of said imaginary polygon; under four corners of the polygon are four pairs of said drive magnets, each with a same pole type 180-degree apart and attached in symmetry on and perpendicular to said two drive axles; they are in turn a first drive magnets pair, a second drive magnets pair, a third drive magnets pair and a fourth drive magnets pair, said first and second drive magnets pairs of opposite pole types on said first drive axle are parallel to each another, and said third and fourth of opposite pole types in turn on said second drive axle are parallel to said imaginary polygon plane, said first and second drive magnets pairs on said first drive axle as the virtual coupling dipole in transient have a 90-degree offset with said third and fourth on said second drive axle; said first and fourth drive magnets pairs are of one pole type and said second and third the opposite pole type; when said first and second drive magnets pairs circulating said first drive axle and said third and fourth circulating said second drive axle in sync but counter direction on planes perpendicular to said drive axles, a stirring element of one N-type and one S-type pole ends, attracted and pulled-and-pushed simultaneously at both ends by said virtual coupling dipoles preconfigured in turn on each of said two drive axles once every ¼ axle-turn, moves in repetitive reciprocating or back-and-forth rolling motion above said imaginary polygon plane; length of said virtual coupling dipoles on respective said drive axles are adjustable and to match dipole distance or length of the stirring element and affect said magnetic attraction force.

10. The dynamic magnetic coupling method of claim 1, wherein said drive magnet use types of permanent magnets like neodymium iron boron (NdFeB), samarium cobalt (SmCo), aluminum nickel cobalt (AlNiCo), and ceramic or ferrite magnets of any shape or aggregated arrangement if of the same size and magnetism density, and with a magnetism stronger than that of said stirring element; said drive magnets are attached and stacked to said drive axle preferably by magnetism.

11. The dynamic magnetic coupling method of claim 1, wherein said stirring element are axially magnetized rod or other shapes with opposite types of magnetic poles at its two ends.

12. A magnetic coupled stirring apparatus, comprising:
a chassis with a top holding surface;
a turning power source attached to said chassis and with a rotating shaft drive;
a magnetic coupling assembly, attached to said chassis, including
a pair of horizontally placed parallel drive axles, turning in sync but in opposite directions by said shaft drive and a set of transmission gears;
an assembly of drive magnets, positioned under four corners of an imaginary polygon plane with four sides, wherein said polygon has two pairs of parallel sides meeting in right angles and one said pair of parallel sides right above said pair of parallel drive axles, said drive magnets mounted on said pair of parallel drive axles along direction of the other said pair of parallel sides; said drive magnets under each said four corners having a rotation plane perpendicular to said pair of parallel drive axles; wherein said rotation plane of each of the said drive magnets is divided into four quadrants 90-degree each for configuring the drive magnet's pole orientations, resulting in a total seat for attachment or mounting of 4-corners times 4-quadrant, a total of 16 of N-type or S-type or none said drive magnets, to provide virtual magnetic coupling pole or dipole runs in steps for different coupling motions every turn of said pair of parallel drive axles; said virtual magnetic coupling dipole have adjustable pole-to-pole distance by expanding said four-corner mounting positions from a square to a rectangle to affect magnetic attraction force and accompanying kinetic momentum of said drive magnets sufficient for coupling motion; wherein space between said pair of parallel drive axles sufficient to match pole-to-pole distance of said virtual magnetic coupling dipole and to mounting and crossing of said drive magnets on their respective rotation planes; and
a stirring element, axially magnetized with one N-type magnetic pole and one S-type pole, placed inside a vessel to affect stir motions for fluid mixing, propulsion or transfer;
wherein said 16 N-type or S-type or none drive magnets' configurations at said four corners under said imaginary polygon can be configured and reconfigured, by corresponding placement on said pair of parallel drive axles 1 or 2, 2 or 4, or 8 drive magnets of N-type and/or S-type to affect, on one or two or four coupling points on said imaginary polygon plane, every turn or half-a-turn or a ¼-turn respectively, magnetic coupling at said stirring element of one N-type and one S-type magnetic pole ends, attracted and pulled-and-pushed at one or both ends by said virtual magnetic coupling pole or dipole runs, prompt its repetitive rhythmic motions above said imaginary polygon plane to affect stir motions for fluid mixing, propulsion or transfer;
wherein said repetitive rhythmic motions of said stirring element include no fewer than rotation in a set direction, a back-and-forth rocking or whiplash motion, and a reciprocating or back-and-forth rolling motion.

13. A magnetic coupled stirring apparatus of a plural number of parallel stirring positions of adjustable space or distance, comprising:
a chassis with a top holding surface for said plural number of parallel stirring positions;
a turning power source attached to said chassis and with a rotating shaft drive;
a magnetic coupling assembly of said plural number of magnetic coupling assembly units, attached to said chassis, including
a pair of horizontally placed parallel drive axles, turning in sync but in opposite directions by said shaft drive and a set of transmission gears; wherein said parallel drive axle pair are of sufficient length to drive said plural number of parallel stirring positions and their respective magnetic coupling assembly units;
an assembly, for said plural number of parallel stirring positions, of same said plural number of parallel magnetic coupling assembly units; said each assembly unit of drive magnets, each positioned under four corners of an imaginary polygon plane with four sides, wherein said polygon has two pairs of parallel sides meeting in right angles and one said parallel sides pair right above said pair of parallel drive axles, said drive magnets mounted on said pair of parallel drive axles along direction of the other pair of said parallel sides; said drive magnets under each said four corners having a rotation plane perpendicular to said pair of parallel drive axles; wherein said rotation plane of each of the drive magnets is divided into four quadrants 90-degree each for configuring the drive magnet's pole orientations, resulting in a total seat for attachment or mounting of 4-corners times 4-quadrant, a total of 16 of N-type or S-type or none said drive magnets, to provide virtual magnetic coupling dipole run in steps for different coupling motions every turn of said pair of parallel drive axles; space or distance between said parallel stirring positions or said each assembly units of drive magnets or said each neighboring imaginary polygon planes are adjustable on said pair of horizontally placed parallel drive axles to match diameter or width of different stirring vessels; said each virtual magnetic coupling dipole have adjustable pole-to-pole distance by expanding said four-corner mounting positions from a square to a rectangle to affect magnetic attraction force and accompanying kinetic momentum of said drive magnets sufficient for coupling motion; wherein space between said pair of parallel drive axles sufficient for length of each said virtual magnetic coupling dipole and for mounting and crossing of all said plural number of parallel magnetic coupling assembly units of drive magnets on their respective rotation planes; and
an assorted stirring elements, axially magnetized with one N-type magnetic pole and one S-type pole, placed, one in each vessel, at said plural number of parallel stirring positions of same or various space to affect stir motions for fluid mixing, propulsion or transfer in each said vessels of same or various diameter or width;
wherein said 16 N-type or S-type or none drive magnets' configurations at each said four corners under each said imaginary polygons can be configured and reconfigured, by corresponding placement on said pair of parallel drive axles 1 or 2, 2 or 4, or 8 drive magnets of N-type and/or S-type to affect, on one or two or four coupling points on each said imaginary polygon planes, every turn or half-a-turn or a ¼-turn respectively, magnetic coupling at each said stirring elements of one N-type and one S-type magnetic pole ends, attracted and pulled-and-pushed at one or both ends by said virtual magnetic pole or dipole runs, prompt its repetitive rhythmic motions above said imaginary polygon plane to affect stir motions for fluid mixing, propulsion or transfer;
wherein said repetitive rhythmic motions of each said stirring elements include no fewer than rotation in a set direction, a back-and-forth rocking or whiplash motion, or a reciprocating or back-and-forth rolling motion, or a mix of them.

14. The magnetic coupled stirring apparatus of claim 13, wherein additional set or sets of said magnetic coupling assembly of said plural number of magnetic coupling assembly units and said parallel drive axle pair can be attached to said chassis to provide additional said parallel stirring positions, said parallel drive axle pair turning speed, and/or specific repetitive rhythmic motions with additional sets of transmission gears and/or turning power source.
